(19) United States
(12) Patent Application Publication
(10) Pub. No.: US 2025/0103383 A1
(43) Pub. Date: Mar. 27, 2025

(54) METHODS AND APPARATUS FOR PROCESSING DATA

(71) Applicant: Arm Limited, Cambridge (GB)

(72) Inventors: Elliot Maurice Simon Rosemarine, London (GB); Daren Croxford, Swaffham Prior (GB)

(21) Appl. No.: 18/474,579

(22) Filed: Sep. 26, 2023

(51) Int. Cl. G06F 9/48

(52) U.S. Cl. CPC G06F 9/4818

(57) ABSTRACT

According to the present techniques there is provided a method of operating a data processor unit to generate processing tasks. The data processor unit comprises a control circuit configured to receive, from a host processor unit, a request for the data processor unit to perform processing jobs and to generate a workload for each job. Each workload comprises one or more tasks. The data processor unit further comprises first and second execution units to process the workloads. The method comprises: receiving, at the control circuit, a request to perform first and second processing jobs; generating, at the control circuit in response to the request, a primary workload for the first processing job, and a secondary workload for the second processing job; generating, at the control circuit, one or more operation instructions to control processing of the primary and/or secondary workloads at the first and/or second execution units; processing, at the first execution unit, the primary workload in accordance with the operation instructions; and processing, at the second execution unit, the secondary workload in parallel with the primary workload in accordance with the operation instructions.

The present techniques generally relate to the field of data processing.

A data processing system may include number of general-purpose processor units and one or more target processor units. Example target processor units include a graphics processor unit (GPU), an array processor, a cryptographic engine, a neural processor unit (NPU) and a digital signal processor (DSP).

The present technology relates to the control of parallel programs in such data processing systems where there exists a need to provide improved processing of data.

According to a first technique there is provided a method of operating a data processor unit to generate processing tasks: the data processor unit comprising: a control circuit configured to receive, from a host processor unit, a request for the data processor unit to perform processing jobs and to generate a workload for each job, where each workload comprises one or more tasks; and first and second execution units to process the workloads, the method comprising: receiving, at the control circuit, a request to perform first and second processing jobs; generating, at the control circuit in response to the request, a primary workload for the first processing job, and a secondary workload for the second processing job; generating, at the control circuit, one or more operation instructions to control processing of the primary and/or secondary workloads at the first and/or second execution units; processing, at the first execution unit, the primary workload in accordance with the operation instructions; and processing, at the second execution unit, the secondary workload in parallel with the primary workload in accordance with the operation instructions.

According to a further technique there is provided a data processor unit for processing tasks a data processor unit comprising: a control circuit configured to receive, from a host processor unit, a request for the data processor unit to perform first and second processing jobs and, in response to the request, to generate: a primary workload comprising one or more tasks for the first processing job; a secondary workload comprising one or more tasks for the second processing job; and one or more operation instructions to control the processing of the primary and/or secondary workloads; a first execution unit to execute the primary workload in accordance with the operation instructions therefor; and a second execution unit to execute the secondary workload in parallel with the primary workload and in accordance with the operation instructions therefor.

According to a further technique there is provided a non-transitory data carrier carrying code which, when implemented on a processor, causes the processor to carry out the methods described herein.

The techniques are diagrammatically illustrated, by way of example, in the accompanying drawings, in which:

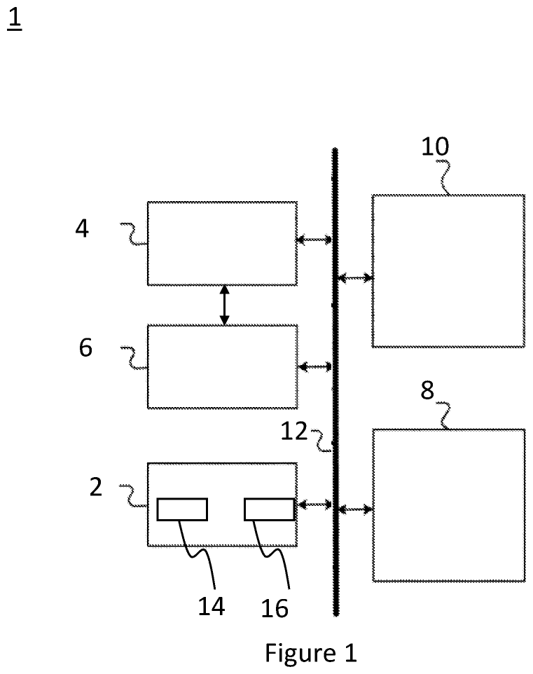

FIG. 1 schematically shows a simplified block diagram of a data processing system in accordance with an embodiment;

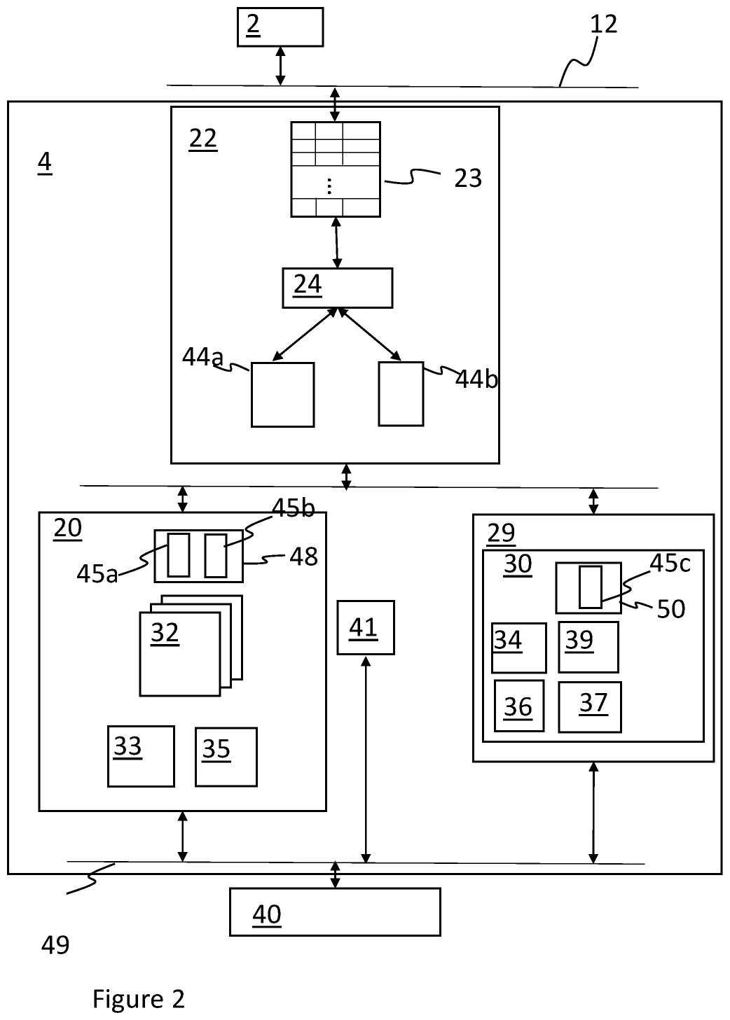

FIG. 2 schematically shows a simplified block diagram of a processor unit;

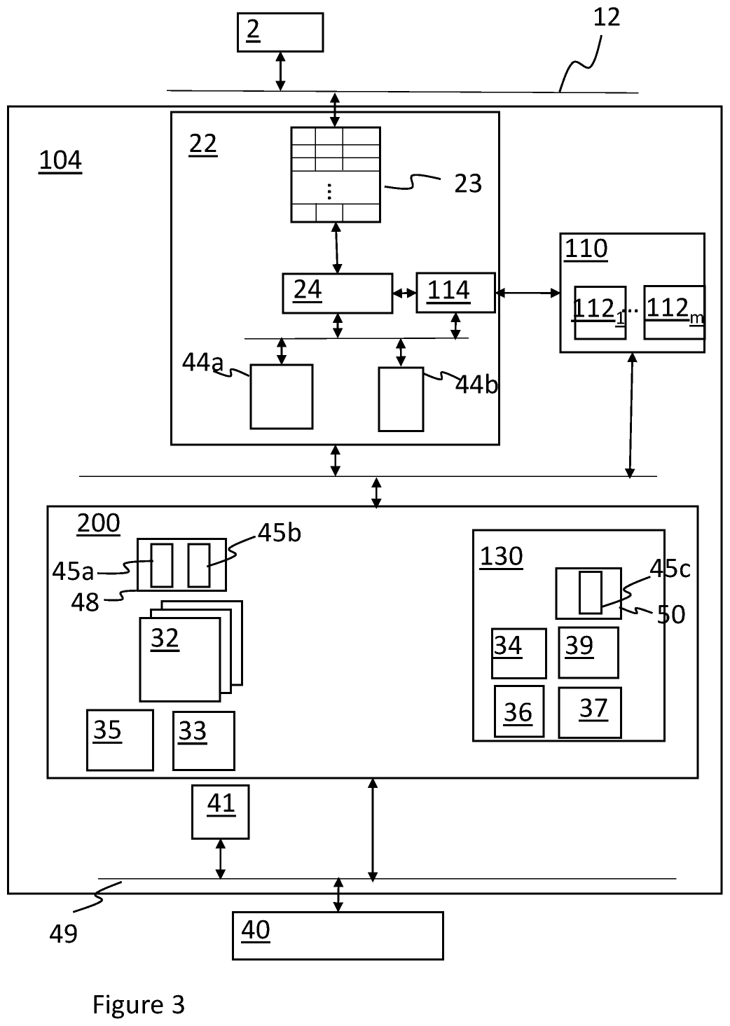

FIG. 3 schematically shows a simplified block diagram of a processor unit in accordance with the present techniques;

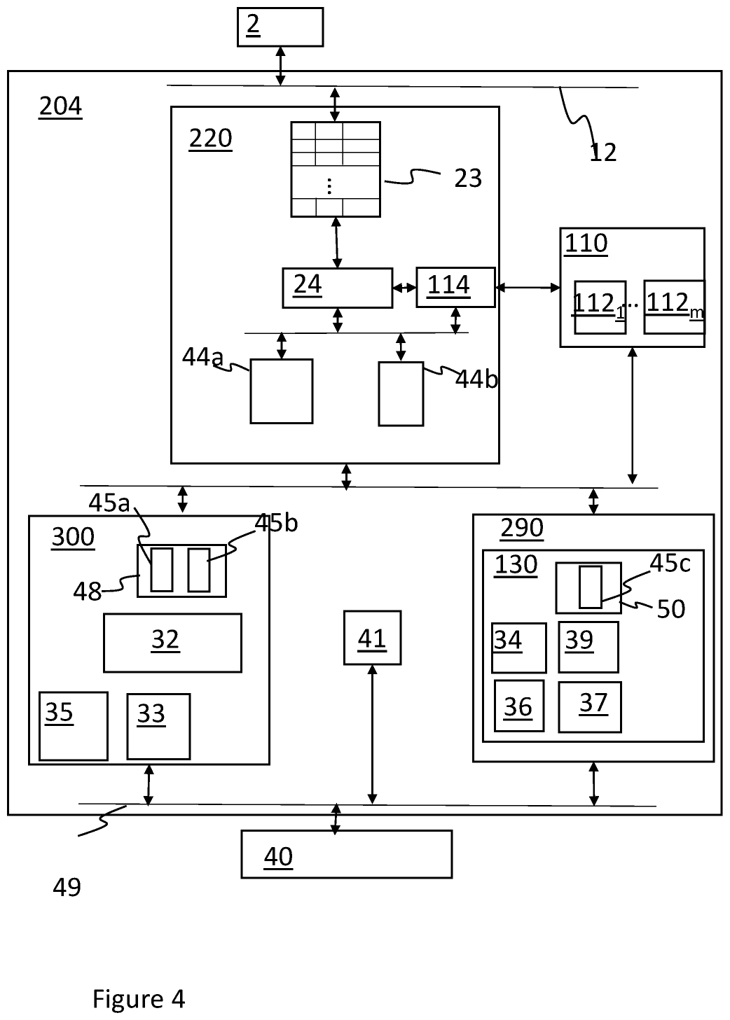

FIG. 4 schematically shows a further simplified block diagram of a processor unit in accordance with the present techniques;

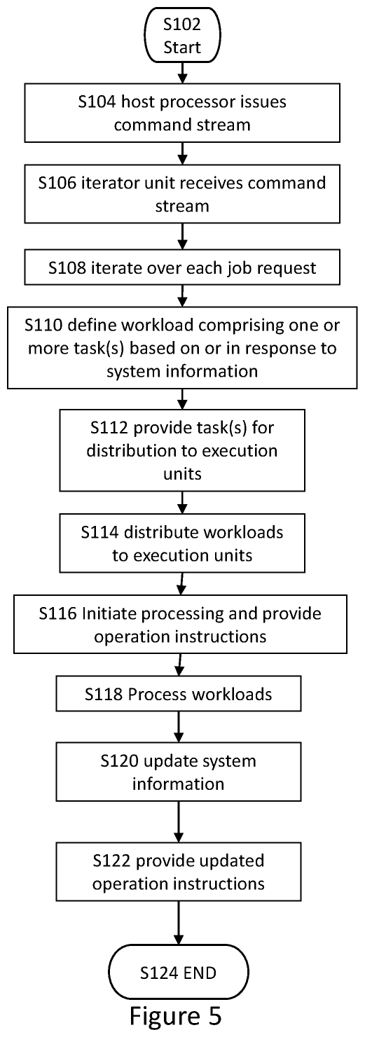

FIG. 5 schematically shows an example process for controlling processing operations at the processor unit(s) of FIG. 3 or 4.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter.

FIG. 1 is a simplified block diagram of a data processing system 1 in accordance with various representative embodiments.

Data processing system 1 includes a number of processing units, which in FIG. 1 are depicted as host processor 2 and target processor units, depicted here as Graphics Processor Unit (GPU) 4 and Neural Processing Unit (NPU) 6. Data processing system 1 also includes storage 8, such as random access memory, and storage device 10, such as a solid state drive, hard disc or other non-volatile storage. The elements of data processing system 1 are connected via an interconnect 12, which may be a coherent interconnect, a network, or bus, for example.

The host processor 2 may comprise, for example, a general-purpose processing core, and is herein referred to as a Central Processing Unit (CPU 2).

GPU 4 executes a graphics processor pipeline that includes one or more processing stages (“shaders”). For example, a graphics processor pipeline being executed by GPU 4 may include one or more of, and typically all of: a geometry shader, a vertex shader and a fragment (pixel) shader. These shaders are programmable processing stages that execute shader programs on input data to generate a desired set of output data in accordance with one or more tasks.

In order to execute shader programs, GPU 4 includes one or more processor cores (or “shader cores” or “cores”)) for that purpose.

The processor core on the GPU 4 comprise programmable processing circuit(s) for executing the graphics programs (e.g. shader programs). GPU 4 may comprise a single processor core as depicted in FIG. 3 below, although GPU 4 may comprise one or more processor cores.

The actual data processing operations that are performed by the processor core when executing a shader program may be performed by one or more execution unit(s) (hereafter “execution engine” (EE) or “graphics execution engine”) having one or more functional units (circuits), such as arithmetic units (circuits), in response to, and under the control of, the instructions in the (shader) program being executed. Thus, for example, appropriate graphics functional units will perform data processing operations in response to and as required by instructions in a (shader) program being executed.

When executing an instruction in a graphics program, the execution engine, will typically perform a processing operation using one or more input data value(s) to generate one or more output data value(s), and then return the output data value(s), e.g. for further processing by subsequent instructions in the program being executed and/or for output (for use otherwise than during execution of the program being executed).

The input data values will typically be stored in storage (e.g. a cache or caches accessible to the execution engine), and the output data value(s) generated by graphics functional unit(s) executing the instruction will correspondingly be written back to an appropriate storage (e.g. cache), for future use. Thus, when executing an instruction, the input data value(s) will be read from an appropriate storage (e.g. cache or caches), and output value(s) written back to that same or different storage.

NPU 6 typically comprises one or more neural execution unit(s) (hereafter “neural engine(s)”), where a neural engine is configured for more efficiently performing neural network processing operations of a particular type or types.

A neural engine may comprise one or more neural functional unit(s) to perform neural network processing operations. Generally speaking, neural network processing requires various, arithmetic operations. For example, when applying a kernel/filter/weight/bias data to an input data array, the processing may comprise performing weighted sums according to a “multiply-accumulate” (MAC) operation and may comprise a plurality of neural functional units in the form of multiplier-accumulator circuits (hereinafter “MAC units”) which are arranged to perform such MAC operations on data structures. Typically the data structures used to represent the data to be used for neural network processing (e.g. the input data, feature map data, weights data, kernel data, filter data, output data, bias data etc.) are multi-dimensional (e.g. 4D+ tensors) and are stored on storage (e.g. cache) accessible to the neural engine.

For example, a neural engine configured to perform tensor arithmetic operations, such as tensor MAC operations, may comprise a plurality of MAC units which are arranged to perform such MAC operations on tensor data structures. The arithmetic operations thus typically comprise tensor arithmetic, e.g. tensor multiplication, addition, and so on.

In the present techniques, a neural core 29 (shown in FIG. 2) is integrated into the GPU 4 to provide neural network processing capabilities for the GPU 4, whereby in embodiments each processor core 20 of the GPU has its own dedicated neural core 29 to provide neural network processing capabilities therefor.

Application 14 executes on host processor 2 and, in the present illustrative embodiments, requires graphics processing operations and/or neural network processing operations to be performed by a target processor (e.g. GPU 4 and/or NPU 6), where a software driver 16 on the host processor 2 generates a command stream(s) to cause the target processor units 4, 6 to operate in response to the command stream(s).

In the present illustrative example, a command stream includes a call or request (hereafter “job request”) for a target processor unit(s) 4, 6 (using one or more functional units thereat) to perform one or more processing jobs or workloads (hereafter “job”), where processing a job comprises running a set of instructions or program (hereafter “program”) over a specified iteration space, where the iteration space comprises data.

The data may comprise input data for programs (e.g. shader programs of a graphics functional unit or neural network processing operations of a neural network functional unit of the NPU 6). A functional unit will then run a specified program over the iteration space.

The job request may comprise instructions, commands or indications (hereafter “job information”) relating to a requested job, for example to set parameters or define the properties or characteristics (hereafter “characteristics”) of the requested job.

An iterator unit at the target processor 4, 6 (i.e. the target processor for the job request) will iterate over (or process) each job request, and in response to, for example, job information therein, divide or partition the iteration space, into a workload comprising one or more processing task(s) (hereafter “task”) that are to be performed by a particular target processor unit 4, 6, where each task comprises a subset of the data (i.e. task data) in the iteration space specified for the job. Performing (or executing or processing) a task comprises applying, at an execution unit, a program over the task data.

The job information in a job request may include pre-defined parameters which specify the characteristics of the job such as the size (e.g. maximum or minimum size) and/or location of the iteration space thereof. The indication specifying the size and/or location of the iteration space may comprise one or more n-Dimensional coordinate(s) specifying an area in storage (e.g. a cache or buffer) storing the data over which a program should be run (e.g. a multi-dimensional data brick or block). The job information may also include pre-set or pre-defined parameters which specify the characteristics of a workload (e.g. defining the number of tasks into which the job should be divided; the no. of processors the tasks should be distributed between, size of the tasks etc.). The job information may also include indications to specify the types of processing operations required (e.g. graphics processing or neural network processing) etc. The job information may also specify which of the execution units (e.g. the execution engine or neural engine) should process the job or individual task(s) divided therefrom.

FIG. 2 shows in more detail the components and elements of the target processor 4, which in the present example is a GPU. It will be appreciated that FIG. 2 shows those elements, units, communications paths, etc., that are particularly relevant to the operation in the manner of the present embodiments. There may be other components, elements, communications paths, etc., that are not shown in FIG. 2.

The GPU 4 of FIG. 2 comprises a processor core 20 having one or more execution engine(s) 32, operable to process a task by applying one or more shader programs over the task data. In the present embodiments, shader program execution is performed at the execution engine(s) 32 for respective groups (warps) of execution threads and processor core 20 comprises execution control unit 48, which is operable to create (issue) groups (warps) of execution threads and manage their execution by the execution engine 32 in accordance with the one or more tasks.

The processor core 20 may comprise further components and units necessary for the execution of (shader) programs, such as, for example, local storage 33 (e.g. one or more register files and/or L0 cache) for storing data for use by the execution engine 32 when executing a (shader) program. The register file(s) may hold registers referenced by the execution engine 32.

Processor core 20 comprises a load/store unit 35 (circuit) operable to load and store data in response to program execution (e.g., from shared storage to the local storage 33 and vice versa).

The load/store unit 35 may have access L1 cache on the processor core and may also have access to off-chip storage 40 (e.g. main memory of the data processing system via GPU storage 41). In the present embodiments the GPU storage 41 is an L2 cache of the storage system cache hierarchy, which may be shared with the neural core 29 (e.g. via interconnect 49 or directly via respective interfaces (not shown)).

The load/store unit 35 is operable to load data into the one or more register files and/or L1 cache and read data from the register file(s) and/or L1 cache and write that data to the shared storage 41.

The neural core 29 may support the execution engine during graphics processing operations. For example, the neural core 29 may be used for non-graphics tasks such as image enhancement for an Image Signal Processor (ISP), video processing or for display. Additionally or alternatively, the neural core 30 may be used to perform Machine Learning (ML) operations as part of the graphics processing pipeline. For example, the rendered output image generated by the GPU may be processed by the neural core 30 to enhance and/or generate further images.

In the present embodiments neural core 29 includes one or more neural execution units 30 (hereafter “neural engine” 30 includes a number of functional units 34, 36 configured to perform particular processing operations for neural network processing, such as, for example, a fixed function convolution unit 34 (e.g. that computes convolution-like arithmetic operations), and one or more other neural functional units 36 (e.g. that compute other arithmetic operations). Each of the fixed function convolution units may comprise one or more MAC units (e.g. in an array), which are arranged to perform such MAC operations on tensor data structures.

The neural engine 30 may also comprise one or more of, and preferably plural of, the following functional units: direct memory access units; a weight decode unit for fetching weights and which may comprise a decompression unit; one or more transform units, e.g. for rearranging data without any effect from the value of individual elements in the data, such as permuting dimensions, duplicating/broadcasting dimensions, inserting/removing dimensions or rearranging data order; one or more elementwise operation units, such as to perform arithmetic operations such as addition, multiplication, etc., logical operations (shifts, etc.), and/or bitwise operations; functional units to perform clamping (ReLU), scaling and/or zero point correction, lookup tables; one or more functional units to perform reduction operations, such as sum, min/max, argmax, argmin, etc.; one or more functional units to perform resize operations, such as scaling H/W dimensions, inserting zeros, replicating neighbours or bilinear filtering. It would also be possible to have functional units that are able to perform plural of the above operations, such as to implement elementwise reduction and resize, for example.

The neural engine 30 also includes local storage 37 (e.g. a buffer), that is operable to store data locally to the neural engine 30 data (both input and output data) that is being used/generated by the functional units 34, 36 when performing processing operations for neural network processing.

The neural engine 30 also includes a storage access unit 39 via which it can transfer data between the storage 40 of the data processing system and the local storage 37 of the neural engine 30.

It will be appreciated that the processor core 20 may contain multiple shader execution engines 32, and any one or more or all of those execution engines 32 may also have an associated neural core 29 to provide neural network processing capability therefor. Alternatively, in other embodiments, two or more execution engines 32 of processor core 20 may share the same neural core 29 or a single graphics execution engine 32 of processor core 20 may share two or more associated neural cores 29.

In the present embodiments the processor core 20 and the neural engine 30 of the GPU 4 share at least some components and elements. For example, the processor core(s) 20 and neural engine 30 have access to the shared storage 41 (e.g. an L1 cache) of the overall memory system hierarchy of the data processing system, via which they are operable to read data from, and write data to, memory 40 of the data processing system. The processor core 20 and neural engine 30 may also share interconnect 49, where the interconnect is to provide a communications path with other components of the data processing system, such as the memory 40.

The neural engine 30 may communicate with the components of the processor 20 via interconnect 49. Additionally or alternatively neural engine 30 may also include a neural interface unit (not shown) that acts as a communications/messaging interface between the neural engine 30 and other components of the processor core 20.

The operation of the appropriate processor core(s) 20 and neural engine(s) 30 may be triggered by means of appropriate command streams comprising job request(s), that are generated and provided to the GPU 4 by host processor 2. Such command streams comprising job request(s) are generated, for example, by driver software at the host processor 2 in response to application(s) running thereon requesting for job(s) to be performed by the GPU 4.

Command stream front end control unit 22 (hereafter “control unit”) receives a command stream from the host processor 2 which includes one or more job requests, each job request comprising job information for a respective job of the one or more job requests.

Control unit 22 comprises storage 23 (e.g. a buffer) to receive and store the command stream(s) comprising the job request(s) generated by a host processor.

The control unit 22 comprises iterator unit(s) (or job iterator unit) 24 to process or iterate over a job request of the one or more job requests, and in response to, for example, job information therein, divides the iteration space (or the data therein), into workloads for each job, where each workload comprises one or more tasks that are to be performed.

The iterator unit 24 allocates the job workloads to a particular execution unit (e.g. the execution engine 32 or the neural engine 30 for processing), and outputs the tasks to respective distribution managers 44a/44b to manage distribution of the workloads to the allocated execution unit. In the present illustrative example, the iterator unit 24 outputs the workload(s) allocated to be performed by the execution engine 32 to distribution manager 44a and outputs the workload(s) allocated to be performed by the neural engine 30 to neural engine distribution manager 44b.

The distribution manager 44a then issues the workload(s) comprising compute tasks to a compute task queue 45a on task control unit 48 at processor core 20 and issues the workload(s) comprising fragment tasks to fragment tasks queue 45b of the processor core 20. The neural engine distribution manager 44b issues the workload(s) comprising neural tasks to a neural task queue 45c on task control unit 50 at the neural engine 30.

The distribution managers 44a/44b may be part of the same control unit 22 as the iterator unit 24 (as depicted in FIG. 2). In further embodiments the distribution managers may be located outside of the iterator unit, on the processor core 20 and Neural engine for example. Although depicted as separate units in FIG. 2, in further embodiments the distribution managers 44a/44b may comprise a single hardware or software component.

The distribution managers 44a/44b also initiate processing in accordance with the schedule. In embodiments the processor core(s) 20 receives a signal from the distribution manager 44a to start processing a received workload. The processor core(s) 20 begins processing the tasks thereof by inter alia fetching the data required to perform the tasks, where the data may be fetched from main memory 40 to shared storage 41 and then via load/store unit 35 to local storage 33.

Similarly, in embodiments, the neural core 29 receives a signal from the distribution manager 44b to start processing a received workload. The neural engine 30 begins processing the tasks thereof by inter alia fetching the data required to perform the neural processing tasks. As above, such data may be weight data, feature map data, tensor data, bias data etc. which may be fetched from main memory 40 and loaded into the shared storage 41, and then to local storage 37.

The distribution managers 44a/44b schedule the workload(s) taking account of dependencies between different jobs. For example, where a first job is dependent on the results of a second job, the distribution managers 44a/44b will schedule the workload for the second job to be processed at an appropriate execution unit (e.g. EE 32 or NE 30), and will schedule the workload of the first job to be processed on an appropriate execution unit only after the second job completes. Thus, the first job will have access to the required dependency data/results when it begins processing.

In examples where there are no dependencies between the first and second jobs and the jobs are allocated to the same execution unit (e.g. the first job is a compute job and second job is a fragment or compute job) then the workload comprising the tasks of the first job will be issued to the same execution unit, e.g. EE 30 at the processor core 20, for processing, and the workload comprising the tasks of the second job will be issued to the processor core 20 only after the first job completes.

In other examples where there are no dependencies between jobs and the jobs are to be allocated to different execution units (where, for example, a first job (e.g. a fragment job) is allocated to the execution engine 32, and a second job (e.g. a neural job) is allocated to the neural engine 30) then the workload of the first job will be processed at the execution engine 32 and once that job completes then the workload of the second job will be processed at the neural engine 30.

Processing workloads for different jobs one after another in this way avoids conflict between shared resources (e.g. processing, power, storage (e.g. cache), data etc.) but results in processing inefficiencies (e.g. due to “bubbles” in the pipeline resulting from the latency resulting from waiting on resources (e.g. data, storage, processing capabilities) to become available).

The present techniques provides mechanisms to manage and distribute the workloads to the appropriate execution units, and to control processing to address processing inefficiencies.

FIG. 3 schematically shows components and elements of target processor 104 in accordance with the present techniques. Like components described above in FIG. 2 will use the same numbering. It will be appreciated that FIG. 3 shows those elements, units, communications paths, etc., that are particularly relevant to the operation in the manner of the present embodiments. There may be other components, elements, communications paths, etc., that are not shown in FIG. 3.

In FIG. 3, processor core 200 includes one or more execution engine(s) 32 (and associated components illustratively shown as local storage 33 (e.g. register and load/store unit 35) and neural engine 130. There may be one or more processor cores 200, each having one or more execution units.

As described above, the scheduling of tasks to be processed one after another avoids conflict between shared resources (e.g. processing, power, storage (e.g. storage 41 or shared storage on the processor core 200 (e.g. where storage 33 may be accessible by neural engine 130 and/or storage 37 on neural engine 130 may be accessible by resources outside of the neural engine), data etc.) but results in processing inefficiencies (e.g. due to “bubbles” in the pipeline resulting from the latency resulting from waiting on resources to become available).

The present techniques attempt to address the processing inefficiencies described above, and in particular for the scenario where there are no dependencies between jobs and the jobs are to be allocated to different execution units (e.g. where a first job is allocated to execution engine 32 and a second job is allocated to the neural engine 130 or vice versa).

Under the approach of the present techniques, two or more execution units may process jobs substantially simultaneously whilst avoiding or at least mitigating the effects of resource constraints by controlling the processing, for example, based on or in response to job information in the command stream and/or system information which, in the present embodiments is maintained in storage 110 at the GPU 104 and may be accessible by one or more software and/or hardware (hereinafter “SW/HW”) resources at the control unit 220, such as the processor core(s) 200.

The system information may be used to convey the operational status of hardware and/or software resources of the GPU 104 (e.g. availability of execution units, speed of the execution units, the functional units being used to process tasks, the no. of functional units, of tasks being processed, available storage, etc.).

As an illustrative example FIG. 3 depicts a GPU 104 comprising an analysis unit 114 and system information storage 110 comprising storage 112. In the present illustrative example the storage comprises status registers 112₁ to 112ₘ (where ‘m’ is an integer (m≥1)), where each register 112 is to store, for example, one or more value(s), and to specify system information. The system information may be maintained or updated in substantially real-time (e.g. by firmware and/or by SW/HW resources) to provide current system information.

The analysis unit 114 can access the system information and determine an operational status of the execution units 130/32 based on or in response to the system information. The analysis unit 114 can then communicate (e.g. via the distribution managers 44a/44b) with the processor core 200 to control the processing operations thereof as will be described in detail below. Whilst the analysis unit 114 and/or the storage 110 is depicted as part of the control unit 220 in FIG. 3, the claims are not limited in this respect and in other embodiments the analysis unit 114 and/or the storage 110 may be part of the processor core 220 or maybe a standalone component at the GPU 104.

In the present techniques the control unit 220 receives a command stream from the host processor 2 which includes one or more job requests, each job request comprising job information for a respective job.

Iterator unit 24 processes or iterates over a job request of the one or more job requests (e.g. in queue 23), and in response to, for example, job information therein, divides the iteration space (or the data therein), into workloads for each job, where each workload comprises one or more tasks that are to be performed.

The iterator unit 24 allocates the job workloads to a particular execution unit to be performed (e.g. execution engine 32 or neural engine 130) and outputs the tasks to respective distribution managers 44a/44b to manage distribution of the workloads accordingly.

The distribution manager 44a then issues any workload(s) comprising compute tasks to a compute task queue 45a on task control unit 48 at processor core 200 and/or issues any workload(s) comprising fragment tasks to fragment tasks queue 45b. The neural engine distribution manager 44b issues any workload(s) comprising neural tasks to a neural task queue 45c. The distribution managers 44a/44b may also initiate processing at the respective execution units 130/32.

In embodiments the processor core(s) 200 receive(s) a signal from the distribution manager 44a to initiate processing of a received workload. The processor core(s) 200 begins processing the tasks thereof by inter alia fetching the data required to perform the tasks, where the data may be fetched from main memory 40 to shared storage 41 and then via load/store unit 35 to local storage 33 (e.g. L0 cache) and performing program execution at the execution engine 32.

Similarly, in embodiments, the neural engine 130 receives a signal from the neural engine distribution manager 44b to initiate processing a received workload. The neural engine 130 begins processing the tasks thereof by inter alia fetching the data required to perform the neural processing tasks and processing tasks on the fixed function execution units 34/36. Such fetched data may be weight data, feature map data, tensor data, bias data etc. which are fetched from main memory 40 and loaded into the shared storage 41, and then to local storage 37 (e.g. L0 cache).

Using the present techniques, and in contrast to the functionality described in FIG. 2, rather than waiting for a first job to complete on a first execution unit before initiating execution of a second job on a second execution unit, processing can be performed for tasks of a primary workload on a first execution unit (e.g. an execution engine 32) and for tasks of a secondary workload on a second execution unit (e.g. neural engine 130) (substantially) in parallel with one another. The processing operations of the execution units 130/32 when processing the primary and/or secondary workloads may be controlled by providing operation instructions to the respective execution units. The operation instructions may be generated by the control unit 220 based on or in response to an analysis of the system information and/or based on or in response to job information in the command stream. The control unit 220 may communicate the operation instructions directly to the respective execution units 130/32 and/or may provide them via the distribution managers 44a/44b. In other examples, the execution engine 32 may generate operation instructions to control processing operations at the neural engine 130 and vice versa.

A workload may be designated a primary workload based on, for example, its position in the job request from the host processor 2, or the designation may be defined in the job information, where first a job designated as a priority may be taken to be the primary workload, and a second job having a lower priority taken to be secondary workload.

In one approach, taken to be a “fixed” approach, for controlling processing operations of the execution units 130/32 when processing the primary and/or secondary workloads, a first execution unit (e.g. neural engine 130) may be controlled (e.g. by operation instructions from the control unit 220) to process tasks of a secondary workload issued thereto at a reduced rate (e.g. reduced processing speed, reduced clock speed) in comparison to the rate at which a second execution unit (e.g. an execution engine) is to process tasks of a primary workload issued thereto. Additionally, or alternatively, the tasks of the secondary workload may be issued to the first execution unit (e.g. neural engine 30) at a reduced frequency in comparison to the frequency that the tasks of the primary workload are issued to the second execution unit (e.g. the execution engine 32).

When implementing the “fixed” approach, the components of the GPU 104 may not perform any real-time analysis and the control may be based on historical performance of how the execution units 130/32 performed when processing similar workloads in the past. Thus, the control unit 220 may control the execution units 130/32 to process the primary and/or secondary workloads in response to information in the command stream (e.g. job information) from the host processor, or in response to instructions in storage on the GPU 104 (e.g. where the instructions in the command stream may be defined by a developer or the owner of the GPU).

In a further approach, taken to be a “static” approach, for controlling processing operations of the execution units when processing the primary and/or secondary workload, the execution units 130/32 may be controlled to execute a primary and/or secondary workload based on or in response to a (static) estimate of the effect (load) that processing the primary and/or secondary workloads would have on the GPU resources. Such an estimate may be generated by, for example, the compiler at the host processor 2 where, for example, neural processing jobs are relatively deterministic (in that there is very little, if any, branching of instructions during processing thereof) and it would be possible to estimate the load that executing the neural tasks of such a workload would have on known GPU resources, and control the rate at which execution engine 32 is to operate when the neural engine 130 is processing the neural workload. The compiler could include the estimate or the required configuration in the job information (e.g. as metadata) when sending the command stream to the GPU 104. As a further example, processing neural tasks using a fixed function convolution unit 34 to perform convolution-like arithmetic operations may be estimated to place an increased load on GPU resources (e.g. increased power consumption) in comparison to processing neural tasks using other neural functional units 36 (e.g. other non-convolution operations). Thus, the execution unit 130/32 processing the secondary workload can be controlled to consume less power when the tasks of the primary workload requires using a fixed function convolution unit to perform convolution-like arithmetic operations in comparison to when the tasks of the primary workload requires using a fixed function convolution unit to perform other non-convolution-like operations.

Similar estimations could be provided for fragment and compute tasks based on the characteristics of the tasks which the iterator unit is to generate.

The processing of the primary and/or secondary workloads may be controlled to meet a particular operational target for a particular resource of the GPU 104. For example, there may be a fixed power budget, so if one execution unit (e.g. execution engine 32) is estimated to use X % of the power budget to process the primary workload, then another execution unit (e.g. neural engine 130) may be controlled to use 100%−(minus) X %. The % may be estimated based on the type of processing that will be performed. For example, processing fragment workloads may be estimated to require X % of the power budget. So when processing a fragment workload as a primary workload at the execution engine 32, a neural workload could be processed in parallel as a secondary workload at the neural engine 130, where the neural engine 130 is controlled (e.g. in response to operation instructions from the control unit 220) to use the remaining power budget. Similarly, processing neural workloads may be estimated to require Y % of the power budget. So when processing a neural workload as a primary workload on the neural engine 130, a fragment or compute workload could be processed in parallel as a secondary workload at the execution engine 32, where the execution engine 32 is controlled to use the remaining estimated power budget (e.g. in response to operation instructions from the control unit 220).

In a further approach, taken to be a “dynamic” approach, for controlling processing operations of the execution units 130/32 when processing the primary and/or secondary workload, the execution units 130/32 may be controlled to execute a primary and/or secondary workload based on or in response to an analysis of the system information during processing, and determining the effect (load) that processing the primary and/or secondary workload is having on the GPU resources (e.g. at a particular moment in time or over a period of time).

For example, an execution unit 130/32 may, when processing a primary or secondary workload, update the system information in storage 110. As set out above, the system information may be indicative of operation status of the first and/or second execution units 130/32, and the analysis unit 114 may analyse the system information in storage 110 and determine (for example):
how many warps are active in the execution engine 32 over a period of time;
whether warps may be stalled in the execution engine 32 (e.g. waiting for data to be returned during a fetch operation);
where there is warp divergence in the execution engine 32;
how many functional unit 34/36 are currently active in the neural engine 130; and/or.
how many MACs are active in the functional units 34/36.

The execution engine 32 may comprise one or more processing pipelines and runs warps through the pipelines when processing the compute or fragment workloads, and the system information in storage 110 may be updated to provide an overview of the status of the execution engine 32, where the execution engine status information may be indicative of the power being consumed by the execution engine 32 during processing operations thereon.

For example, the execution engine status information may be updated to indicate the number of warps active or the number of pipelines active in the execution engine 32. Furthermore, the execution status information may be updated to indicate warp divergence in the execution engine 32 during processing.

When the execution engine 130 is processing a primary workload, then the processor core 200 can update the execution engine status information in the system information in storage 110.

The analysis unit 114 can analyse the execution engine status information and control processing operations of the neural engine 130 to reduce the power consumption thereof while the neural engine 130 is processing the secondary workload in parallel with the execution engine 32 processing the primary workload to, for example, meet a power budget threshold for the GPU 104 or reduce the burden on shared resources (e.g. shared cache). Such control of processing operations of the neural engine 130 may comprise reducing the number of MAC units in a functional unit 34/36.

When the neural engine 130 is executing a primary or secondary workload, then the neural engine 130 can update the neural engine status information in the system information in storage 110.

For example, the functional unit(s) 34/36 of the neural engine 130 comprise MAC units which perform MAC operations on data when processing the neural workloads, and the system information in storage 110 may be updated to provide an overview of the status of the neural engine 130 over a period of time, where the neural engine status information may be indicative of the power being consumed by the neural engine 130 during processing operations thereon.

The analysis unit 114 can analyse the neural engine status information and control processing operations of the execution engine 32 to reduce the power consumption thereof when processing the secondary workload in parallel with the neural engine 130 processing a primary workload to, for example, meet a power budget threshold for the GPU 104. Such control of processing operations of the execution engine 32 may comprise issuing operation instructions in response to the analysis to reduce the number of pipelines of the execution engine 32, insert bubbles into the pipeline of the execution engine 32; and/or reduce the clock rate of the execution engine 32.

Neither of the examples of system information above nor the information derived therefrom are exhaustive. In a further approach a static estimation may be used when a workload starts and dynamic analysis performed subsequently.

It may be detrimental to the GPU 104 to start processing tasks on an execution unit 130/32 at substantially full execution speed, or to cease processing tasks when processing tasks at substantially full execution speed as doing so may result in power transients, which may result in corruption of data. Thus, the speed or capacity of an execution unit 130/32 may be controlled dependent on the processing phase of the workload. As an illustrative example, an execution unit 130/32 may be controlled so as to ramp-up the speed of execution at the beginning of workload and/or to ramp-down execution at the end of a workload.

As an illustrative example, for an execution engine 32 during ramp up, the number of threads processed in the a pipeline thereof may be increased in an incremental manner until the execution engine 32 is at operational speed or capacity. Similarly, during ramp-down, the number of threads processed in the execution engine 32 may be decreased in a decremental manner. As a further illustrative example, for a neural engine 130 during ramp-up, the number of MAC units used to process tasks may be increased in an incremental manner, whilst during ramp-down, the number of MAC units may be decreased in a decremental manner.

The load on GPU resources will reduce during the ramp-up phase of a workload or during the ramp-down phase of a workload, whereby, for example, power consumption on the execution unit 130/32 processing the workload will reduce during those times.

Therefore, by determining when the ramp-up and ramp-down phases will occur when a first execution unit (e.g. execution engine 32) is processing a primary workload, a second execution unit (e.g. neural engine 130) executing a secondary workload may be controlled so as to consume more power during the ramp-up and ramp-down phase of the primary workload (e.g. by utilizing more MAC units), and to consume less power between the ramp-up and ramp-down phases of the primary workload (e.g. by powering off MAC units). The control unit 220 may determine, e.g. in response to the job information in the command stream, when the ramp-up and ramp-down phases will occur and control the first and second execution units 130/32 accordingly.

The system information can also provide a status of the other GPU resources such as the storage (e.g. shared storage 41).

When, during processing a primary workload by a first execution unit, it is determined based on or in response to the system information (e.g. by the analysis unit 114) that the shared storage 41 is at capacity, the execution unit 130/32 processing the secondary workload may be instructed to fetch any data required from, for example, main memory 40.

In embodiments, the control unit 220 may, using the analysis unit 114, determine the load that running workloads would have on one or more GPU resources (e.g. shared storage, power consumption etc.), and then control processing operations of respective execution units by issuing operation instructions to instruct the execution units as to when and how to process the workloads to maintain the load within an acceptable level (e.g. within a threshold).

In embodiments, the execution units (or other components of the processor core 200/neural engine 130) may communicate with each other to modify or synchronise processing operations thereof. For example, the processing speed of an execution engine 32 processing a primary workload may slow down and a neural engine processing a secondary workload may receive operation instructions, where the operation instructions (e.g. from the processor core) are to control the processing operations at the neural engine (e.g. to speed up processing of the secondary workload whilst continuing to meet a resource budget (e.g. a system power budget; storage budget).

Similarly, the power consumption of a neural engine processing a primary workload may increase and the neural engine may communicate with one or more components of the processor core 200 to send operation instructions thereto, where the operation instructions from the neural engine are to control the processing operations at the execution engine processing a secondary workload (e.g. to slow down processing of the secondary workload, whilst continuing to meet a resource budget).

In embodiments the designation of a workload may be changed while it is being processed at an execution unit. For example, a primary workload may be redesignated as a secondary workload or vice versa, where such redesignation may be based on or in response to, for example, a workload completing or a change in system requirements.

As an illustrative example, a primary workload processed at a first execution unit may be redesignated as a secondary workload and a secondary workload processed at a second execution unit may be redesignated as a primary workload. Such redesignation may be based on or in response to a change in system requirements, where for example there may a change in a resource budget or a change in available resources.

As a further illustrative example, when a primary workload at a first execution unit completes before a secondary workload at a second execution unit, a new workload may be issued to the first execution unit. The new workload may be designated as the primary workload, and the first execution unit may process the new workload as the primary workload in parallel with the secondary workload being processed at the second execution unit. Alternatively, the secondary workload may be redesignated as the primary workload and processed as such at the second execution unit, and the new workload designated as the secondary workload and processed as such at the first execution unit.

Thus, such redesignation of workloads will result in the respective execution units switching from processing a primary workload to processing a secondary workload (and vice versa).

This redesignation of workloads would apply to the fixed, static and/or dynamic approaches set out above.

Whilst FIG. 3 above depicts the execution units used to process the primary and secondary workloads (i.e., the execution engine 32 and neural engine 130) as being part of the same processor core the claims are not limited in this respect and FIG. 4 illustratively shows target processor 204 comprising processor core 300 having execution unit 32 and neural core 290 having neural engine 130. There may be one or more processor cores 204, each having one or more execution units 32 and/or one or more neural engines 130.

In a similar manner as described above in FIG. 3, the two or more execution units 32/130 may process jobs substantially simultaneously whilst avoiding or at least mitigating the effects of resource constraints by controlling the processing, for example, based on or in response to job information in the command stream and/or system information in storage 110 at the GPU 104.

The techniques described herein provide for controlling processing of different jobs across a plurality of execution units in an efficient manner whilst meeting resource constraints and reducing the load on resources by different execution units where the load on shared resources can be balanced between the different execution units.

FIG. 5 schematically shows an example process for controlling processing operations at the target processors of FIGS. 3 & 4 schematically shown above.

At S102, the process starts.

At S104, an application executing on host processor which requires one or more tasks to be performed by a target processor unit (e.g. GPU and/or NPU), transmits (e.g. using a software driver) a command stream comprising job requests to the target processor unit for the target processor unit to perform processing jobs. Each job request comprises job information comprising instructions for each job.

At S106, the target processor (i.e. the target of the job request) receives the command stream.

At S108 the iterator unit iterates over each job request, and at S110, divides the iteration space (or the data therein) into workloads, each workload having one or more processing tasks that are to be performed by execution units (e.g. execution engine or neural engine(s)) at the target processor unit.

At S112, the iterator unit outputs the tasks to respective distribution managers to manage distribution of the workloads to the allocated execution units. In the present illustrative example, the iterator unit outputs the workloads allocated to be performed by the execution engine(s) to a EE distribution manager and outputs the workloads allocated to be performed by a neural engine(s) to a NE distribution manager.

At S114, the distribution managers issue or distribute the workloads to respective queues (e.g. fragment queue, compute queue, neural queue) at the execution units.

At S116, the distribution managers initiate processing in accordance with the schedule by, for example, providing a signal to the respective queues to issue the tasks of the workloads to the respective execution units, and also provide operation instructions to control processing operations on the respective execution units. In other embodiments, the operation instructions may be provided by another resource (e.g. the control unit may communicate with the execution units to provide operation instructions thereto).

The operation instructions may be derived from information in the command stream (e.g. job information). For example, the information in the command stream may specify a desired resource budget (e.g. power budget) that the GPU is to meet, and the GPU may issue the operation instructions so that the execution units process primary and secondary tasks to meet the resource budget. Additionally, or alternatively, the operation instructions may be generated (e.g. at the control unit) based on or in response to system information, which may be updated by the execution units as described above.

At S118 the execution units process the workloads allocated thereto where, in the present techniques, two or more execution units may process jobs in parallel, where a first execution unit processes a primary workload and/or a second execution unit processes a secondary workload in accordance with the operation instructions. A workload may be designated a primary workload based on, for example, its position in the job request from the host processor, or the designation may be defined in the job information, where a job designated as a priority may be taken to be the primary workload, and a next job in the command stream having a lower priority taken to be secondary workload.

At S120, the respective execution units update the system information.

At S122, an analysis unit processes the updated system information and provides updated operation instructions to control processing operations on the respective execution units where the updated operation instructions are based on or in response to an analysis of the system information. On receiving the updated operation instructions the first execution unit processes the primary workload in accordance with the updated operation instructions and/or a second execution unit processes a secondary workload in accordance with the updated operation instructions. Furthermore, the execution units may communicate with each other to modify or synchronise the processing operations thereof, where the where the execution engine (or other component of the processor core) may issue operation instructions to the neural engine to control the processing operations at the neural engine (e.g. to meet a resource budget (e.g. a system power budget; storage budget)). Similarly, the neural engine may issue operation instructions to the execution engine to control the processing operations at the execution engine (e.g. to meet a resource budget (e.g. a system power budget; storage budget)). At S124 the process ends.

Using the present techniques described above, the control unit can control processing operations of respective execution units to instruct the execution units as to when and how to process the workloads to attempt to maintain processing operations within a resource budget(s) (e.g. power budget; storage budget; bandwidth).

Such functionality, means that a primary workload can be processed on a first execution unit (e.g. an execution engine) and a secondary workload can be processed on a second execution unit (e.g. a neural engine) in parallel with one another, where the processing operations of the first and/or second execution units can be controlled to ensure that processing on the first and second execution units does not exceed any resource budget(s) and reduces the burden on resources shared by the execution units (e.g. shared cache).

Such functionality also provides for load balancing where the load on shared resources can be balanced between the different execution units.

The techniques described above are applicable to processing operations on a target processor, such as graphics processing operations on a GPU or neural network processing operations on an NPU. In particular, the techniques are particularly applicable to parallel processing operations.

The data processing system described above may be arranged within a data system-on-chip system. The data processing system may be implemented as part of any suitable electronic device which may be required to perform neural network processing, e.g., such as a desktop computer, a portable electronic device (e.g. a tablet or mobile phone), or other electronic device.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The techniques further provides processor control code to implement the above-described systems and methods, for example on a general purpose computer system or on a digital signal processor (DSP). The techniques also provides a carrier carrying processor control code to, when running, implement any of the above methods, in particular on a non-transitory data carrier-such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™, VHDL (Very high speed integrated circuit Hardware Description Language) or SystemVerilog hardware description and hardware verification language. As the skilled person will appreciate, such code and/or data may be distributed between a plurality of coupled components in communication with one another. The techniques may comprise a controller which includes a microprocessor, working memory and program memory coupled to one or more of the components of the system.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended items.

What is claimed is:

1. A method of operating a data processor unit to generate processing tasks:
the data processor unit comprising:
a control circuit to receive, from a host processor unit, a request for the data processor unit to perform processing jobs and to generate a workload for each job, where each workload comprises one or more tasks; and
first and second execution units to process the workloads,
the method comprising:
receiving, at the control circuit, a request to perform first and second processing jobs;
generating, at the control circuit in response to the request, a primary workload for the first processing job, and a secondary workload for the second processing job;
generating, at the control circuit, one or more operation instructions to control processing of the primary and/or secondary workloads at the first and/or second execution units;
processing, at the first execution unit, the primary workload in accordance with the operation instructions; and
processing, at the second execution unit, the secondary workload in parallel with the primary workload in accordance with the operation instructions.

2. The method of claim 1, where generating, at the control circuit, one or more operation instructions comprises:
generating the operation instructions in response to job information in the request.

3. The method of claim 1, where generating, at the control circuit, one or more operation instructions comprises:
generating the operation instructions based on or in response to system information in storage.

4. The method of claim 3, further comprising:
updating, with the first execution unit and/or the second execution unit, the system information in storage in response to processing the respective workloads.

5. The method of claim 1, where processing, at the second execution unit, the secondary workload in parallel with the primary workload in accordance with the operation instructions comprises:
processing tasks of the secondary workload at the second execution unit at a different rate in comparison to the rate at which the first execution unit processes tasks of the primary workload.

6. The method of claim 5, where the different rate is a reduced rate, and where the second execution unit processes tasks of the secondary workload at a reduced processing speed or reduced clock speed.

7. The method of claim 5, where the tasks of the secondary workload are issued to the second execution unit at a different frequency in comparison to the frequency that the tasks of the primary workload are issued to the first execution unit.

8. The method of claim 1, further comprising:
analysing system information during processing of the primary workload and/or the secondary workload; and
in response to the analysis, updating system information in storage.

9. The method of claim 8, where the system information in storage is indicative of a status of at least one component of the data processor unit.

10. The method of claim 8, where the system information in storage comprises real-time or current system information.

11. The method of claim 8, further comprising:
analysing, with an analysis unit, the system information in storage during processing of the primary workload and/or the secondary workload.

12. The method of claim 11, further comprising:
determining an operational status of the first execution unit and/or the second execution unit based on or in response to the analysis of the system information in storage during processing of the primary workload and/or the secondary workload.

13. The method of claim 12, further comprising:
based on or in response to the operational status of the first execution unit and/or the second execution unit, issuing further operation instructions to the first execution unit and/or the second execution unit.

14. The method of claim 1, where processing, at the first execution unit, the primary workload in accordance with the operation instructions and/or processing, at the second execution unit, the secondary workload in parallel with the primary workload in accordance with the operation instructions comprises:
processing the primary and/or secondary workload based on or in response to an estimate of the effect that processing the primary and/or secondary workloads would have on system resources.

15. The method of claim 14, where processing the primary and/or secondary workload based on or in response to an estimate of the effect that processing the primary and/or secondary workloads would have on system resources comprises:
executing the primary workload and/or the secondary workload to meet an operation target, a resource usage target and/or a resource budget.

16. The method of claim 1, where processing, at the first execution unit, the primary workload in accordance with the operation instructions and/or processing, at the second execution unit, the secondary workload in parallel with the primary workload in accordance with the operation instructions is based on the processing phase of the workload.

17. A data processor unit comprising:
a control circuit configured to receive, from a host processor unit, a request for the data processor unit to perform first and second processing jobs and, in response to the request, to generate:
a primary workload comprising one or more tasks for the first processing job;
a secondary workload comprising one or more tasks for the second processing job; and
one or more operation instructions to control the processing of the primary and/or secondary workloads;
a first execution unit to execute the primary workload in accordance with the operation instructions therefor; and
a second execution unit to execute the secondary workload in parallel with the primary workload and in accordance with the operation instructions therefor.

18. The data processor unit of claim 17, where a first execution unit comprises an execution engine and where the second execution unit comprises a neural engine.

19. The data processor unit of claim 17, where the data processor unit comprises one or more shader cores, each shader core having two or more execution units.

20. A non-transitory computer readable storage medium comprising code which when implemented on a processor causes the processor to carry out the method of claim 1.
